(19) United States
(12) Patent Application Publication
(10) Pub. No.: US 2023/0347929 A1
(43) Pub. Date: Nov. 2, 2023

(54) VEHICLE CONTROL SYSTEM WITH INTERFACE BETWEEN DATA PROCESSING PATHS

(71) Applicant: ZF Friedrichshafen AG, Friedrichshafen (DE)

(72) Inventor: Gerhard MÜLLER, Bad Waldsee (DE)

(73) Assignee: ZF Friedrichshafen AG, Friedrichshafen (DE)

(21) Appl. No.: 17/926,534

(22) PCT Filed: May 4, 2021
(86) PCT No.: PCT/EP2021/061646

§ 371 Date: Nov. 18, 2022

(30) Foreign Application Priority Data
May 19, 2020 (DE) 10 2020 206 295.1

(51) Int. Cl. B60W 60/00; B60W 50/00

(52) U.S. Cl. CPC B60W 60/001; B60W 50/00; B60W 2556/00

(57) ABSTRACT

A control system for a vehicle contains a computing unit having first and second subunits. The first subunit has a first interface for receiving first sensor data, a processor for performing first control functions, and a first connection unit for transmitting the first sensor data to the first processor. The second subunit has a second interface for receiving second sensor data, a second processor for performing second control functions, and a second connection unit for transmitting the second sensor data to the second processor. The first connection unit has a first data exchange block and the second connection unit has a second data exchange block. The first data exchange block transmits the first sensor data to the second data exchange block, and the second data exchange block transmits the first sensor data to the second processor. The second processor performs the second control functions based on the first sensor data.

The invention relates to a control system for a vehicle and a vehicle that has such a control system.

Numerous sensors are used in autonomous vehicles for scanning the vehicle's environment and controlling the vehicle on the basis thereof. The sensors can be radar, camera and lidar sensors. The term sensor can also be used when the sensor has its own processor and outputs processed environment data. The data from the various sensors are compiled in general in a central control unit and processed to obtain a consolidated model of the environment. The driving behavior is then controlled on the basis of this model of the environment and the driving order. The central control unit is composed in general of one or more powerful processors in order to process the large amount of input data. This input data may be distributed to numerous processors within the computing unit. In particular with systems that should be safeguarded against malfunctioning it is necessary to distribute sensor data from different sensor interface units to different processors, in order to make use of independent paths.

A common approach is to have paths that can ensure a minimal functioning with a portion of the sensor data, and for there to be a main path that uses the data from all of the sensors in order to enable a maximal functioning. A known approach is the duplication of the interface units within the system in order to distribute the data accordingly. These interface units generally have different standards and transmission protocols. This requires numerous connections. Another disadvantage may also be that many signals may exceed the limits between different supply areas.

The object of the invention is to reduce and/or simplify the interface units between two independent data processing paths in a control system, and to increase the flexibility of the data transmission between the data processing paths.

These problems are solved by the subject matter of the independent claims. Further embodiments of the invention can be derived from the dependent claims and the following description.

One aspect of the invention relates to a control system for a vehicle. The vehicle can be a semiautonomous or autonomous vehicle. The vehicle can be a passenger automobile, truck, or bus. The control system can comprise numerous sensors and a central control unit that controls the autonomous or semiautonomous driving behavior of the vehicle, e.g. in that it generates control commands for a drive, braking system and steering system.

The control system in one embodiment of the invention contains a computing unit with a first subunit and second subunit, wherein the first subunit receives and processes sensor data from at least one first sensor, and performs first vehicle control functions on the basis thereof, and the second subunit receives and processes second sensor data from at least one second sensor, and performs second vehicle control functions on the basis thereof. The first and second sensors comprise radar, camera, and lidar sensors, for example. The first subunit and second subunit can be redundant units, which can perform their control functions only on the basis of the sensor data that they receive. The first and second control functions can comprise the creation of a model of the environment and/or classification of the sensor data on the basis of machine learning algorithms, for example. The first and second control functions can also comprise controlling the vehicle on the basis of the driving order and the evaluated first and/or second control data.

The first subunit according to one embodiment of the invention contains at least one first interface unit for receiving the first sensor data, one first processor for performing the first control functions, and one first connection unit for transmitting the first sensor data to the first processor. The second subunit can also contain at least one second interface unit for receiving the second sensor data, one second processor for performing the second control functions, and one second connection unit for transmitting the second sensor data to the second processor. Each of the subunits can provide a data transmission path from the respective sensors to the respective processors via the interface unit and the connection unit.

It should be understood that the connection units and/or processors can have the same design. The processors can be high power computers. They can comprise CPUs, GPUs and/or modules that simulate neural networks.

It should also be understood that there can be numerous first interface units that are connected to numerous first sensors, and/or numerous second interface units that are connected to numerous second sensors.

The first connection unit contains a first data exchange block and the second connection unit contains a second data exchange block according to one embodiment of the invention. The first data exchange block is configured to transmit the first sensor data to the second data exchange block and the second data exchange block is configured to transmit the first sensor data to the second processor. The second processor is configured to perform the second control functions on the basis of the first sensor data. It can also be the case that the second data exchange block is configured to transmit the second sensor data to the first data exchange block, and the first data exchange block is configured to send the second sensor data to the first processor, and the first processor is configured to perform the first control functions on the basis of the second sensor data.

The first data exchange block and second data exchange block thus form an interface unit between the two subunits. All of the sensor data exchanged between the two subunits can be sent over these interface units.

The first processor and second processor can perform their functions on the basis of the first and second sensor data. The first and second subunits can also provide redundant functions if only the first sensor data or second sensor data are received, for example. This may be the case if sensors that provide these data malfunction.

The number and types of interface units between the two subunits can be reduced with the interface units provided by the first data exchange block and second data exchange block. The data exchange can take place via a single shared intermediate connection.

The transmission of sensor data between the first data exchange block and second data exchange block takes place according to one embodiment of the invention with an exchange protocol. The exchange protocol can be a standard protocol such as PCI express or Ethernet. The first data exchange block can translate the first sensor data received in a first sensor transmission protocol into the exchange protocol. The second data exchange block can also translate the second sensor data received in a second sensor transmission protocol into the exchange protocol.

The first sensor transmission protocol and second sensor transmission protocol can be the same protocol and/or they can be based on the same or different standard protocols. By way of example, the first sensor transmission protocol and/or second sensor transmission protocol can be Ethernet or CAN bus protocols. In general, a protocol refers to a data transmission process in this context. The protocol can be defined by a standard, or it can be a proprietary protocol.

The transmission of sensor data between the first data exchange block and second data exchange block takes place according to one embodiment of the invention by means of differential signaling, in order to separate the first subunit and second subunit with regard to an electrical potential. The coupling of the data exchange blocks and thus the subunits can take place via an AC (alternating current) coupling. This is so that the data exchange takes place using a differential pair of signals. Differential signaling involves transmitting signals with voltages of opposite polarities on two lines. Such a transmission can be implemented with a CAN bus or Ethernet, for example.

In the case of the loss of a power supply for one of the subunits, a reverse supply from another supply area can be prevented with differential signaling. This can increase the reliability of the control system and/or the computing unit, because more easily separated power supplies are provide for the different independent data transmission paths.

The first subunit receives first sensor data from at least two first sensors according to one embodiment of the invention. The data exchange between the first data exchange block and second data exchange block can take place using a time-slot method in which first sensor data from different first sensors are transmitted in successive time slots. In the same manner, the second subunit can also receive second sensor data from at least two second sensors. The data exchange between the first data exchange block and second data exchange block in this case can also take place using a time-slot method in which second sensor data are transmitted from different second sensors in successive time slots. The time-slot method can take place in particular with a static data rate for each type of sensor data. The sensor data can be transmitted sequentially with a predictable latency. It is possible to separate different virtual channels at the lowest protocol levels via corresponding bit encoding processes.

The first connection unit conducts the first sensor data, which are encoded in the first sensor transmission protocol, to the first processor in the first sensor transmission protocol according to one embodiment of the invention. The second connection unit can also send the second sensor data, which are encoded in a second sensor transmission protocol, to the second processor in the second sensor transmission protocol. In other words, the first and second sensor data are only sent through the respective connection units, without altering the protocol structures.

It is possible that the first and/or second sensor data both come from at least two first and/or second sensors and are both encoded in at least two different sensor transmission protocols. These first and/or second sensor data can be sent to the first and/or second processors without being altered.

The first connection unit has a first protocol conversion block according to one embodiment of the invention, with which the first sensor data, which are encoded in a first sensor transmission protocol, are translated into a first processor transmission protocol and then sent to the first processor. The second connection unit can also have a second protocol conversion block, with which the second sensor data, which are encoded in a second sensor transmission protocol, are translated into a second processor transmission protocol and then sent to the second processor. As a result, the respective processors must only be configured to process the processor transmission protocol. The sensor data from different sensors, which may be encoded in different protocols, can be transmitted to the respective processors via the same interface unit. The processor transmission protocol can be PCI express, by way of example.

It is also possible for the first and/or second sensor data to both come from at least two first and/or second sensors, and to each be encoded in at least two different sensor transmission protocols. These at least two different sensor transmission protocols can be translated by the respective protocol conversion blocks into the processor transmission protocol.

According to one embodiment of the invention, the first sensor data, which have been translated into the first processor transmission protocol, are translated into the exchange protocol by the first data exchange block to be sent to the second data exchange block. It is also possible for the second sensor data, which have been translated into the second processor transmission protocol, to be translated into the exchange protocol by the second data exchange block, to be sent to the first data exchange block. As a result, the data exchange blocks only have to translate one type of protocol.

It is also possible for the first and/or second processor transmission protocols to be the same as the exchange protocol.

Instead of translating the one or more sensor transmission protocols directly into the processor transmission protocol, the one or more sensor transmission protocols can be translated into an intermediate transmission protocol, which is then translated into the processor transmission protocol and the exchange protocol. By way of example, the sensor data can be sorted in a first step, such that they can more easily be translated into the processor transmission protocol and the exchange protocol. As a result, the data does not have to be sorted twice.

In one embodiment of the invention, the first connection unit contains a first protocol conversion block, with which the first sensor data, which have been encoded in a first sensor transmission protocol, are translated into a first intermediate transmission protocol. The first sensor data, which have been translated into the first intermediate transmission protocol, can then be translated into the first processor transmission protocol by the first protocol conversion block, and sent to the first processor. The first sensor data, which have been translated into the first intermediate transmission protocol, can be translated into the exchange protocol by the first data exchange block, to be sent to the second data exchange block.

In the same manner, the second connection unit can contain a second protocol conversion block, with which the second sensor data, which have been translated into a second sensor transmission protocol, are translated into a second intermediate transmission protocol. The second sensor data, which have been translated into the second intermediate transmission protocol, can be translated into the second processor transmission protocol by the second protocol conversion block, and sent to the second processor. The second sensor data, which have been translated into the second intermediate transmission protocol, can be translated into the exchange protocol by the second data exchange block, to be sent to the first data exchange block.

It is also possible for the first and/or second sensor data to come from at least two first and/or second sensors, and to be encoded in at least two different sensor transmission protocols. These at least two different sensor transmission protocols can be translated by the respective protocol conversion block into the intermediate transmission protocol.

In one embodiment of the invention, the first connection unit and second connection unit are hardware modules. All of the components of the first connection unit and second connection unit, such as the first and second data exchange blocks and/or the first and second protocol conversion blocks, can be in the form of hardware.

The first connection unit and second connection unit can each be an FPGA. FPGAs support different interface standards and/or interface protocols, which therefore do not have to be implemented separately. Because their logic systems can be configured in different ways, FPGAs offer a flexibility that makes it possible to implement and combine the connection units efficiently.

The first connection unit and second connection unit can also be implemented in the form of ASICs. Other solutions for the connection units are also fundamentally possible, such as switches, hubs, etc.

Another aspect of the invention relates to a vehicle that has the control system described above, which is described in greater detail below. In addition to the control system, the vehicle can also comprise a drive and other actuators such as a braking system and/or steering system.

Exemplary embodiments of the invention shall be explained in detail below in reference to the drawings.

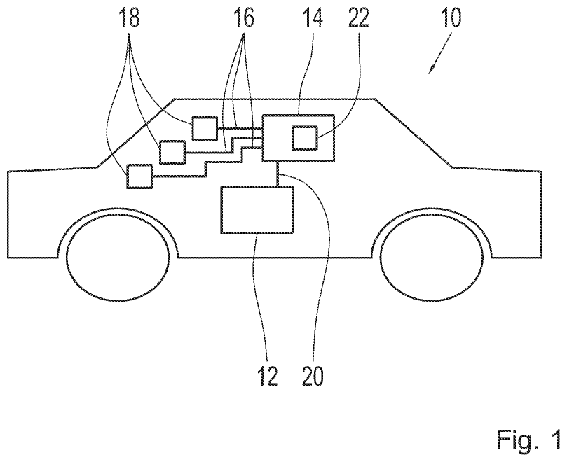

FIG. 1 shows a schematic illustration of a vehicle according to one embodiment of the invention.

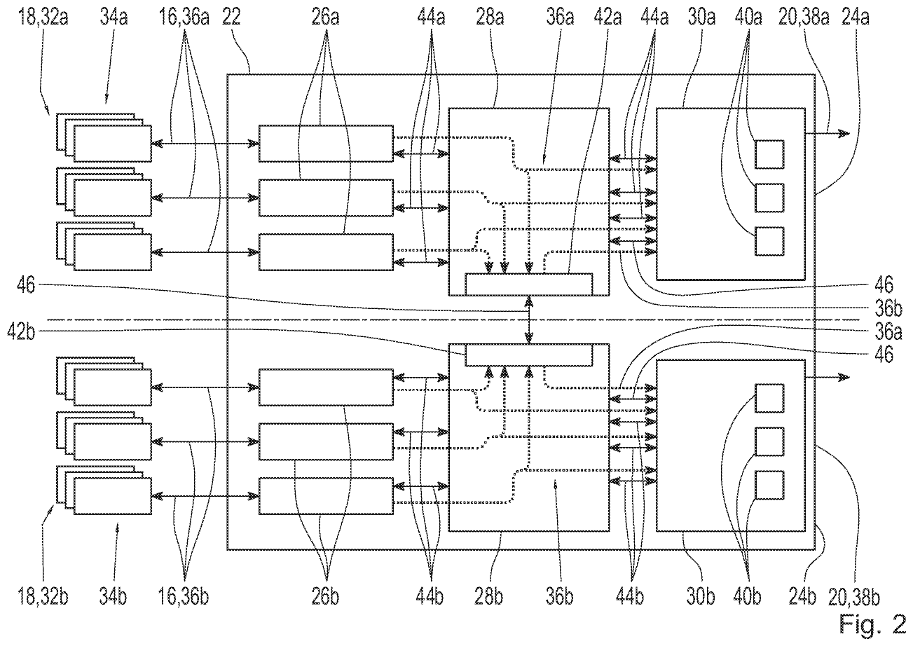

FIG. 2 shows a schematic illustration of a control system according one embodiment of the invention.

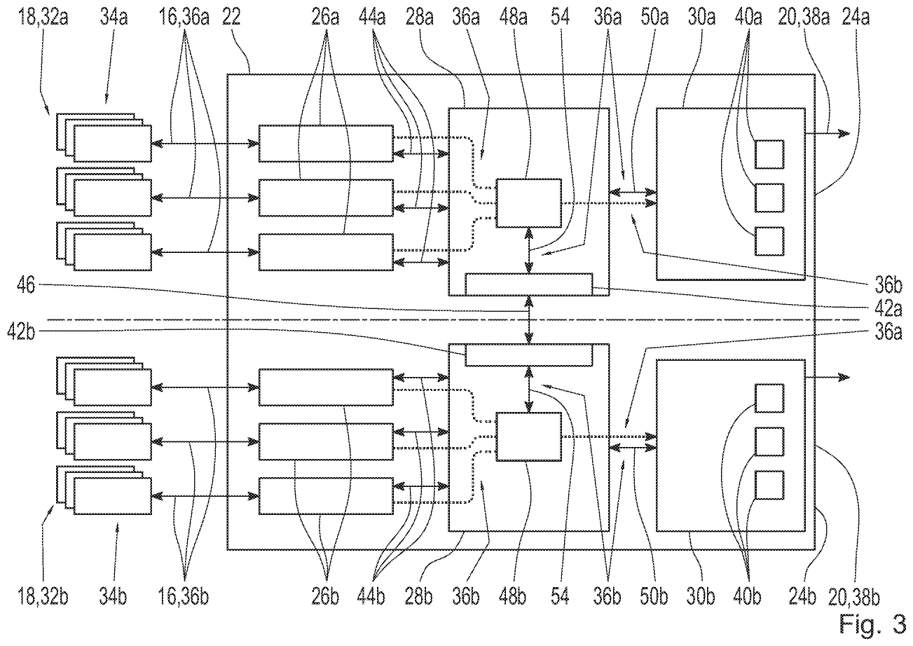

FIG. 3 shows a schematic illustration of control system according to another embodiment of the invention.

The reference symbols are listed with the elements to which they refer in the list of reference symbols. Identical or similar parts are given the same reference symbols.

FIG. 1 shows a schematic illustration of a vehicle 10, which can be an autonomous or semiautonomous vehicle. The vehicle 10 has a drive 12, which can comprise a motor, steering system, and braking system. The drive 12 is controlled by a control system 14, which receives sensor data 16 from numerous sensors 18, and outputs control commands 20 to the drive 12. The control system 14 comprises one or more computing units 22, which can comprise processors, memories, and other hardware modules with which the control system 14 can process the sensor data and perform its functions.

FIG. 2 shows a computing unit 22 in greater detail. The computing unit has two subunits 24a, 24b, which can be regarded as discrete data processing paths. Each of these subunits 24a, 24b contains interface units 26a, 26b, a connection unit 28a, 28b, and a processor 30a, 30b.

FIG. 2 also shows numerous sensors 32a, 32b, which are grouped according to their types. These sensors 32a, 32b can comprise radar, lidar and/or camera sensors. The sensors 32a, 32b are divided into two groups 34a, 34b. The first group 34a of first sensors 32a sends first sensor data 36a to the first interface units 26a. The second group 34b of second sensors 32b sends second sensor data 36b to the second interface units 26b. The sensor data 36a, 36b can also be of different types, e.g. radar data, lidar data, image data, etc. The sensor data 36a, 36b can also be transmitted from the sensors 32a, 32b to the interface units 26a, 26b with different transmission standards and/or transmission protocols, e.g. Ethernet, CAN bus, etc. Each of the interface units 26a, 26b in a subunit 24a, 24b can be configured for a transmission standard and/or transmission protocol.

It should be understood that the components 26a, 26b, 28a, 28b, 30a, 30b can be hardware modules in the computing unit 22.

As shall be described in greater detail below, the sensor data 36a, 36b are forwarded to the processors 30a, 30b via the connection units 28a, 28b. The sensor data 36a, 36b are indicated by broken lines. Using the connection units 28a, 28b, it is possible for both processors 30a, 30b to receive and process the sensor data 36a, 36b that are sent to the respective subunits 24a, 24b in a normal operation thereof. It is also possible for the processors 30a, 30b to perform their functions when certain sensors 32a, 32b malfunction and/or their connections to the computing unit 22 are interrupted, when only the sensor data 36a, 36b from their subunits 24a, 24b are received and/or when only the sensor data 36a, 36b in another subunit 24a, 24b are received. The subunits 24a, 24b can provide redundant data paths in this manner.

The processors 30a, 30b can comprise CPUs, GPUs and/or other hardware modules with which machine learning algorithms can be performed, which evaluate and classify the sensor data 36a, 36b, and generate control commands 38a, 38b for the drive therefrom. In general, the first processor 30 performs first control functions 40a, and the second processor 30b performs second control functions 40b.

In summary, the control system 14 contains a computing unit 22 with a first subunit 24a and a second subunit 24b, wherein the first subunit 24a receives and processes first sensor data 36a from at least one first sensor 32a, and performs first control functions 40a of the vehicle 10 on the basis thereof, and the second subunit 24b receives and processes second sensor data 36b from at least one second sensor 32b, and performs second control functions 40b of the vehicle 10 on the basis thereof. The first subunit 24a has at least one interface unit 26a for receiving the first sensor data 36a, a first processor 30a for performing the first control functions 40a, and a first connection unit 28a for transmitting the first sensor data 36a to the first processor 30a. The second subunit 24b has at least one second interface unit 26b for receiving the second sensor data 36b, a second processor 30b for performing the second control functions 40b, and a second connection unit 28b for transmitting the second sensor data 36b to the second processor 30b.

Each of the connection units 28a, 28b has a data exchange block 42a, 42b with which the two subunits 24a, 24b can exchange sensor data 36a, 36b. The data exchange blocks 42a, 42b convert the sensor data 36a, 36b, which can be encoded and/or transmitted in different sensor transmission protocols 44a, 44b and/or transmission standards, into an exchange protocol 46. The respective sensor data 36a, 36b are then sent with the exchange protocol 46 to the other data exchange block, and then sent from the other connection unit 28a, 28b to the associated processor, also by means of the exchange protocol 46, for example.

The transmission of sensor data 36a, 36b between the first data exchange block 42a and second data exchange block 42b takes place by means of an exchange protocol 46. The first sensor data 36a, which are received in a first sensor transmission protocol 44a, are translated the into the exchange protocol 46 by the first data exchange block 42a. The second sensor data 36b, which are received in a second sensor transmission protocol 44b, are also translated the into the exchange protocol 46 by the second data exchange block 42b.

As shown in FIG. 2, the first sensor data 36a can be encoded and/or transmitted to the first connection unit 28a by means of the first sensor transmission protocols 44a. The first sensor transmission protocols 44a can be of different types. The second sensor data 36b can be encoded and/or transmitted to the second connection unit 28b by means of the second sensor transmission protocols 44b. The second transmission protocols 44b can be of different types. It is also possible for the first sensor transmission protocols 44a and second transmission protocols 44b to be of the same type, and/or different types. The types of transmission protocols can be Ethernet, PCI express, CAB bus, etc. and/or defined with the specific standards.

In summary, the first data exchange block 42a is configured to transmit the first sensor data 36a to the second data exchange block 42b. The second data exchange block 42b is configured to transmit the first sensor data 36a to the second processor 30b. The second processor 30b is configured to perform the second control functions 40b on the basis of the first sensor data 36a. In the same manner, the second data exchange block 42b s configured to transmit the second sensor data 36b to the first data exchange block 42a, wherein the first data exchange block 42a is configured to transmit the second sensor data 36b to the first processor 30a, and the first processor 30a is configured to perform the first control functions 40a on the basis of the second sensor data 36b.

Because there is only one interface unit between the two subunits 24a, 24b, this interface unit can also be used to decouple the two from one another. The data transmission between the two data exchange blocks can take place with an AC coupling, or with an AC coupled signal. In particular, the transmission of sensor data 36a, 36b between the first data block 42a and second data block 42b can take place with differential signaling, in order to separate the first subunit 24a from the second subunit 24b with regard to an electrical potential.

Furthermore, the standardized interface unit can be used to exchange the sensor data 36a, 36b between the subunits 24a, 24b in the same manner. The sensor data 36a, 36b can be exchanged via a single physical channel that has been subdivided into numerous virtual channels. A time slot method can be used for this. In particular, sensor data 36a, 36b from various sensors can be transmitted in different time slots.

The first subunit 24a can receive first sensor data 36a from at least two first sensors 32a and the data exchange between the first data exchange block 42a and second data exchange block 42b can take place using a time slop method in which the first sensor data 36a from various first sensors 32a are transmitted successively in time slots. In the same manner, the second subunit 24b can receive second sensor data 36b from at least two second sensors 32b and the data exchange between the first data exchange block 42a and second data exchange block 42b can take place using a time slot method in which second sensor data 36b from various second sensors 32b are transmitted successively in time slots.

As is shown in FIG. 2, the connection units 28a, 28b can be configured such that the sensor data 36a, 36b that have been encoded in the sensor transmission protocols 44a, 44b are transmitted in this form to the processors 30a, 30b. In particular, the first connection unit 28a can forward the first sensor data 36a, which have been encoded in a first sensor transmission protocol 44a, to the first processor 30a in the first sensor transmission protocol 44a. The second connection unit 28b can also forward the second sensor data 36b, which have been encoded in a second sensor transmission protocol 44b, to the second processor 30b in the second sensor transmission protocol 44b. The requires that the corresponding processor 30a, 30b be configured to be able to process all of these sensor transmission protocols 44a, 44b.

FIG. 3 shows a computing unit 22 that, aside from the differences described below, can have the same design as the computing unit 22 in FIG. 2. The computing unit in FIG. 3 has connection units 28a, 28b that each contain a protocol conversion block 48a, 48b.

Protocol conversion blocks 48a, 48b first translate the sensor data 36a, 36b optionally into an intermediate transmission protocol 54 and into a processor transmission protocol 50a, 50b. The sensor data 36a, 36b can then be translated into the exchange protocol by the data exchange block 42a, 42 from the intermediate transmission protocol 54, or directly from the processor transmission protocol 50a, 50b. By way of example, the sensor data 36a, 36b can first be recoded into another format with the intermediate transmission protocol 54, from which the sensor data 36a, 36b can be generated in the processor transmission protocol 50a, 50b and the exchange protocol 46 with less computing effort.

On the whole, the first sensor data 36a, which are encoded in a first sensor transmission protocol 44a, are translated into the first processor transmission protocol 50a by the first protocol conversion block 48a, and forwarded to the first processor 30a. The second sensor data 36b, which are encoded in a second sensor transmission protocol 44b, are translated into the second processor transmission protocol 50b by the second protocol conversion block 48b, and forwarded to the second processor 30b.

The first sensor data 36a, which have been translated into the first processor transmission protocol 50a, can then be translated into the exchange protocol 46 by the first data exchange block 42a. The second sensor data 36b, which have been translated into the second processor transmission protocol 50b, can then be translated into the exchange protocol 46 by the second data exchange block 42b.

It is also possible for the first sensor data 36a, which have been translated in the first protocol conversion block 48a into the first sensor transmission protocol 44a, to be translated into an intermediate transmission protocol 54, and the first sensor data 36a, which have been translated into the intermediate transmission protocol 54, can subsequently be translated into the first processor transmission protocol 50a, and forwarded to the first processor 30a. In this case, the first sensor data 36a, which have been translated into the intermediate transmission protocol 54, can then be translated into the exchange protocol 46 by the first data exchange block 42a.

In the same manner, the second sensor data 36b, which are encoded in a second sensor transmission protocol 44b, can be translated into the intermediate transmission protocol 54 by the second protocol conversion block 48b, with which the second sensor data 36b, which have been translated into the intermediate transmission protocol 54, are subsequently translated into the second processor transmission protocol 50, and then forwarded to the second processor 30b. The second sensor data 36b, which have been translated into the intermediate transmission protocol 54, can then be translated the into the exchange protocol 46 by the second data exchange block 42b.

In both FIG. 2 and FIG. 3, the first connection unit 28a and second connection unit 28b can be hardware modules in the form of FPGAs for example. The logic system for the protocol translation described above can be implemented in these hardware modules. In particular, the data exchange blocks 42a, 42b and/or the protocol conversion blocks 48a, 48b can be implemented in the form of hardware.

The data path from the first processor 30a via the first connection unit 38a to the second connection unit 28b and from there to the second processor 30b can also be used for the data exchange between the processors 30a and 30b. In the same manner, the data transmission can take place in the opposite direction, from the second processor 30b to the first processor 30a. A conversion of the protocols takes place in a manner comparable to the conversion of the protocols for the sensor data.

It should also be noted that the term “comprising” does not exclude any other elements or steps, and “one” or “a” do not exclude a plurality. It should also be noted that features or steps described in reference to any of the exemplary embodiments described above can also be used in combination with other features or steps in other exemplary embodiments described above. Reference symbols in the claims are not to be regarded as limiting.

### REFERENCE SYMBOLS

10 vehicle

12 drive

14 control system

16 sensor data

18 sensor

20 control commands

22 computing unit

24a first subunit

24b second subunit

26a first interface unit

26b second interface unit

28a first connection unit

28b second connection unit

30a first processor

30b second processor

32a first sensor

32b second sensor

34a first group

34b second group

36a first sensor data

36b second sensor data

38a first control command

38b second control command

40a first control function

40b second control function

42a first data exchange block

42b second data exchange block

44a first sensor transmission protocol

44b second sensor transmission protocol

46 exchange protocol

48a first protocol conversion block

48b second protocol conversion block

50a first processor transmission protocol

50b second processor transmission protocol

54 intermediate transmission protocol

1-11. (canceled)

12. A control system for a vehicle comprising:
a computing unit with a first subunit and a second subunit,
wherein the first subunit is configured to receive and process sensor data from at least one first sensor, and perform first control functions of the vehicle on a basis thereof,
wherein the first subunit comprises:
at least one first interface unit configured to receive the first sensor data;
a first processor configured to perform the first control functions; and
a first connection unit configured to transmit the first sensor data to the first processor,
wherein the second subunit comprises:
at least one second interface unit configured to receive the second sensor data;
a second processor configured to perform the second control functions; and
a second connection unit configured to transmit the second sensor data to the second processor,
wherein the first connection unit comprises a first data exchange block and the second connection unit comprises a second data exchange block,
wherein the first data exchange block is configured to transmit the first sensor data to the second data exchange block,
the second data exchange block is configured to transmit the first sensor data to the second processor,
wherein the second processor is configured to perform the second control functions on a basis of the first sensor data,
wherein the first connection unit contains a first protocol conversion block configured to:
translate the first sensor data, which are encoded in a first sensor transmission protocol, into an intermediate transmission protocol;
translate the first sensor data, which have been translated into the intermediate transmission protocol, into a first processor transmission protocol; and
forward the first sensor data, which have been translated into the first processor transmission protocol, to the first processor,
wherein the first data exchange block is configured to translate the first sensor data, which have been translated into the intermediate transmission protocol, into an exchange protocol to be sent to the second data exchange block.

13. The control system according to claim 12, wherein:
the second data exchange block is configured to transmit the second sensor data to the first data exchange block;
the first data exchange block is configured to transmit the second sensor data to the first processor; and
the first processor is configured to perform the first control functions on a basis of the second sensor data.

14. The control system according to claim 12,
wherein the transmission of sensor data between the first data exchange block and the second data exchange block takes place with the exchange protocol,
wherein the first data exchange block is configured to translate the first sensor data, which have been received in the first sensor transmission protocol, into the exchange protocol, and
wherein the second data exchange block is configured to translate the second sensor data, which have been received in a second sensor transmission protocol, into the exchange protocol.

15. The control system according to claim 12,
wherein the transmission of sensor data between the first data exchange block and the second data exchange block takes place using differential signaling, so as to separate the first subunit and second subunit with regard to an electrical potential.

16. The control system according to claim 12,
wherein the first subunit is configured to receive the first sensor data from at least two first sensors, and
wherein the data exchange between the first data exchange block and the second data exchange block takes place with a time slot method in which first sensor data from each one of the at least two first sensors are transmitted successively in time slots.

17. The control system according to claim 12,
wherein the second subunit receives the second sensor data from at least two second sensors, and
wherein the data exchange between the first data exchange block and the second data exchange block takes place with a time slot method in which second sensor data from each one of the at least two second sensors are transmitted successively in time slots.

18. The control system according to claim 12,
wherein the first connection unit is configured to forward the first sensor data, which are encoded in the first sensor transmission protocol, to the first processor in the first sensor transmission protocol.

19. The control system according to claim 12,
wherein the second connection unit is configured to forward the second sensor data, which are encoded in a second sensor transmission protocol, to the second processor in the second sensor transmission protocol.

20. The control system according to claim 12,
wherein the second connection unit comprises a second protocol conversion block configured to:
translate the second sensor data, which are encoded in a second sensor transmission protocol, into a second processor transmission protocol; and
forward the second sensor data, which have been translated into the second processor transmission protocol, to the second processor.

21. The control system according to claim 20,
wherein the first data exchange block is configured to translate the first sensor data, which have been translated into the first processor transmission protocol, into the exchange protocol to be sent to the second data exchange block.

22. The control system according to claim 20,
wherein the second data exchange block is configured to translate the second sensor data, which have been translated into the second processor transmission protocol, into the exchange protocol to be sent to the first data exchange block.

23. The control system according to claim 12, wherein the second connection unit comprises a second protocol conversion block configured to:
translate the second sensor data, which are encoded in a second sensor transmission protocol, into the intermediate transmission protocol;
translate the second sensor data, which have been translated into the intermediate transmission protocol, into a second processor transmission protocol; and
forward the second sensor data, which have been translated into the second processor transmission protocol, to the second processor,
wherein the second data exchange block is configured to translate the second sensor data, which have been translated into the intermediate transmission protocol, into the exchange protocol to be sent to the first data exchange block.

24. The control system according to claim 12,
wherein the first connection unit and second connection unit are hardware modules in which the first data exchange block and the second data exchange block comprise hardware.

25. A vehicle comprising the control system according to claim 12.
